(19) United States
(12) Patent Application Publication
(10) Pub. No.: US 2008/0126411 A1
(43) Pub. Date: May 29, 2008

(54) DEMOGRAPHIC PREDICTION USING A SOCIAL LINK NETWORK

(75) Inventors: Dong Zhuang, Beijing (CN); Benyu Zhang, Beijing (CN); Heng Zhang, Bellevue, WA (US); Jeremy Tantrum, Shoreline, WA (US); Teresa B. Mah, Bellevue, WA (US); Hua-Jun Zeng, Beijing (CN); Zheng Chen, Beijing (CN); Jian Wang, Beijing (CN)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/535,160

(22) Filed: Sep. 26, 2006

(51) Int. Cl. G06F 7/00

(52) U.S. Cl. 707/104.1

(57) ABSTRACT

A system, method, computer-readable media, and related techniques are disclosed for predicting demographic information of a user. A social link network is created and a search request for demographic information related to a first user within the social link network is received. The requested demographic information based on the demographic information of other users connected to the first user within the social link network is provided.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Some online users register and provide demographic information. The demographic information may include age, gender, country and/or city of residence, occupation, interests, income, and the like. However, many online users may not be registered, and therefore have not provided their demographic information voluntarily. Additionally, registered users may give incomplete or even incorrect demographic information. Online advertisers prefer to target ads at a specific audience. The target audience can be selected using demographic information provided by the user. For example, a user who has indicated they are a homeowner may be provided with target advertisements related to home repair. Incomplete and non-existent user profiles of demographic attributes can limit the usage of demography-based ads targeting. Therefore, it may be desirable to provide an approach in which user demographic attributes can be predicted even if a user is not registered or has an incorrect or incomplete profile.

### SUMMARY

A method, system, and computer-readable media are disclosed for predicting demographic information of a user. The method includes identifying a first user within a social link network and identifying other users connected to the first user within the social link network. The method further includes identifying demographic information of each of the connected users, and predicting the demographic information of the first user based on the demographic information of the connected users.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram of an operating environment for implementing the invention in accordance with an embodiment of the present invention;

FIG. 2 is a block diagram of a social link manager in accordance with an embodiment of the present invention;

FIG. 3 is a block diagram of a structure of a social link network in accordance with an embodiment of the present invention; and

FIG. 4 is a flow diagram of an exemplary method for predicting a user's demographic information in accordance with an embodiment of the present invention.

### DETAILED DESCRIPTION

The invention relates to predicting the demographic information of web users who have not previously submitted their demographic information with a registering entity, or users who have provided incomplete or inaccurate demographic information to a registering entity. The invention is able to predict the demographic information of such users by examining users with known demographic information that are within their social link network. A social link network is created by linking users together that have made a connection with each other on the Internet. The social link network can help predict the demographic information of non-registered users and users with incomplete or inaccurate demographic information.

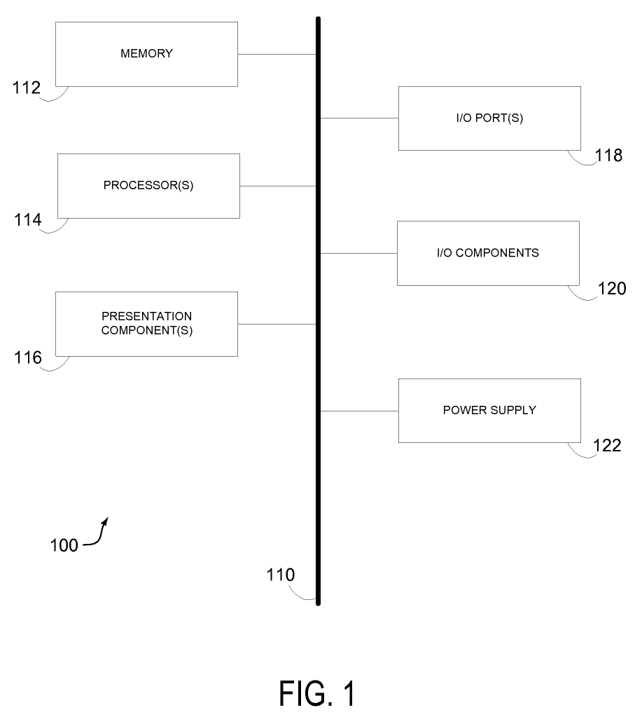

Referring initially to FIG. 1 in particular, an exemplary operating environment for implementing the invention is shown and designated generally as computing device 100. computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would be more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

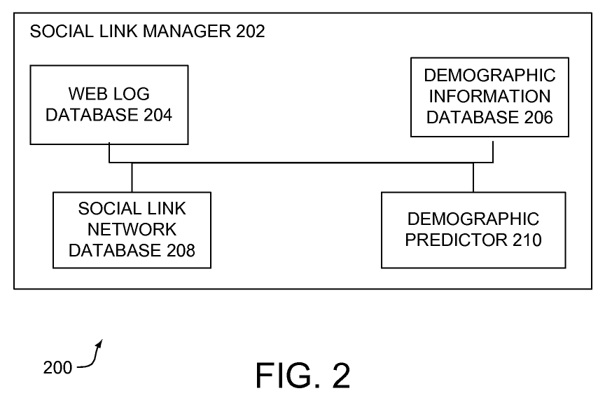

FIG. 2 is a block diagram 200 of a social link manager 202 in accordance with an embodiment of the present invention. Social link manager may be located on a server such as a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. In embodiments of the invention, social link manager 202 can be a search engine, a component of a search engine, or a component that can work in conjunction with a search engine.

Social link manager 202 can be used to create a social link network that can be used to predict demographic information of users. Social link manager 202 can include components such as web log database 204, demographic information database 206, social link network database 208, and demographic predictor 210. In embodiments of the invention, one or more of the components 204, 206, 208, 210 may be external to the social link manager 202. In such embodiments, social link manager 202 can still have access to each component.

Web log database 204 can be used to monitor and store the web activity of users. Such web activity can include web pages visited by users, search queries submitted by users, web content accessed or downloaded from the Internet, or any other type of activity done using the Internet. The web log database 204 can associate web activity with the corresponding user. The user may be associated with his/her web activity within the web log database 204 through use of an identifier. The identifier can be anything that can be used to distinguish one user from another. Such an identifier can be, for example, a user ID or an IP address, however, the invention is not limited to only those two examples.

Demographic information database 206 can be used to store demographic information of users. Demographic information can include, but is not limited to, age, gender, country and/or city of residence, occupation, interests, income, and family information. Users may be associated with their corresponding demographic information within the demographic information database 206 through use of an identifier. The identifier may be any type of identifier as described above. The demographic information within the demographic information database 206 can come from registered users who have previously submitted their demographic information with a registering entity. The registering entity may be, for example, the social link manager 202. In other embodiments, the social link manager can aggregate demographic information from external registering entities. Additionally, the demographic information within the demographic information database 206 can be demographic information that has been predicted for particular users.

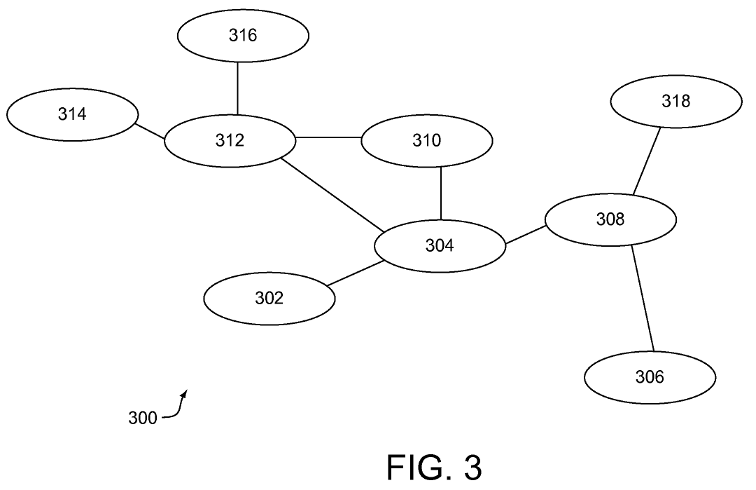

Social link network database 208 can be used to store a social link network that has been created. The social link network can be created by connecting users together that have a social relationship with each other. In an embodiment, the social relationship between two or more users can be determined by evaluating the web log database 204 to see if the two or more users have interacted with each other over the Internet. FIG. 3 is a block diagram 300 of a structure of a social link network in accordance with an embodiment of the present invention. Within the social link network, users may be represented by nodes such as nodes 302, 304, 306, 308, 310, 312, 314, 316, 318. A direct line from one node to another node represents a relation between the two users. For example, node 304 has a relationship with nodes 302, 308, 310, and 312; node 308 has a relationship with nodes 304, 306, and 318; and node 302 has a relationship with just node 304.

Demographic predictor 210 may be employed to predict the demographic information of a user. In an embodiment, the demographic predictor 210 can predict demographic information in response to receiving a request for the demographic information of a user. In another embodiment, the demographic predictor can be configured to periodically predict the demographic information of users whose demographic information is unknown, for those users whose demographic profile is incomplete, or for those users whose demographic information is believed to be false. The demographic predictor can utilize social link network database 208 and demographic information database 106 to predict the demographic information of a particular user by evaluating the demographic information of users that are connected to the particular user within the social link network.

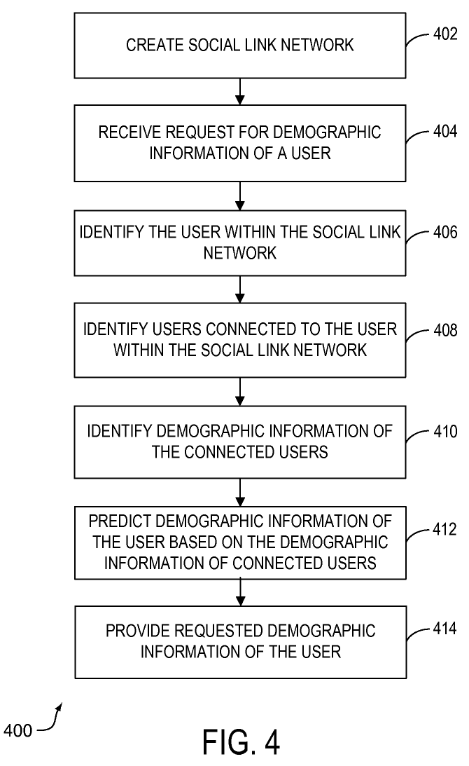

FIG. 4 is a flow diagram 400 of an exemplary method for predicting a user's demographic information in accordance with an embodiment of the present invention. At operation 402, a social link network is created. As mentioned above, the social link network can be created by connecting users together that have a social relationship with each other. For example, the web log database 204 (FIG. 2) can be evaluated to see if the two or more users have interacted with each other over the Internet. In an embodiment, interaction between users that may lead to users being connected together within the social link network can be determined by messenger activity. For example, a first user can be connected to a second user within the social link network through such messenger activity such as the first user adding the second user to his/her instant messenger contact list and vice versa.

In another embodiment, users can be connected to each other within the social link network through blog activity. There can be many types of blog activity that can lead to users being connected with each other within the social link network. One type of blog activity can be leaving comments on someone's blog page. For example, if a first user leaves a comment on a second user's blog page, the first and second user can then be connected within the social link network. Another type of blog activity is “track back.” “Track back” is a term that describes an event when a user copies some type of multimedia data from another user's blog page and posts the copied multimedia data into his/her own blog page. For example, if a first user copies and pastes an article into his/her own blog page that he/she found on a second user's blog page, then the first and second user can be connected with each other within the social link network. Another type of blog activity can occur when a first user includes within their blog page a link to a second user's blog page. This type of blog activity can also lead to the first and second users being connected to each other within the social link network. Yet another type of blog activity is users visiting other user's blog pages. For example, every user that visits a first user's blog page can be connected with the first user within the social link network.

At operation 404, a request for the demographic information of a user is received. At operation 406, the requested user is identified within the social link network. At operation 408, users that are connected with the requested user within the social link network are identified. At operation 410, at least some of the demographic information of one or more users connected with the requested user is identified. In an embodiment, identifying the demographic information of the connected users can involve accessing the demographic information database 206 (FIG. 2).

At operation 412, demographic information for the requested user can be predicted based on the demographic information of the connected users. In an embodiment, the requested user has to have at least three connected users with known demographic information in order to have his/her demographic information predicted. In another embodiment, the requested user has to have at least three connected users with or without known demographic information in order to have his/her demographic information predicted. In such an embodiment, the connected users with unknown demographic information can have their demographic information predicted first by evaluating users connected to them so that the requested user can have his/her demographic information predicted. For example, referring back to FIG. 3, suppose node 308 represented the requested user. Node 308 is directly connected to nodes 306, 304, and 318. Suppose that nodes 318 and 306 each have known demographic information and node 304 does not have any known demographic information. Assuming that there is known demographic information for nodes 302, 312, and 310, the demographic information for node 304 may be predicted. The demographic information predicted for node 304 can then be used to predict the demographic information of node 308.

In an embodiment, the requested user's age can be predicted by calculating the median age of the connected users. For example, if the requested user is connected to five users with corresponding ages of 22, 23, 24, 25, and 26, the requested user's age will be predicted to be 24. In other embodiments of the invention, the requested user's age is predicted by calculating the mean or mode of the ages of the connected users. In an embodiment, the user's geographical location can be predicted by identifying the most common geographical location among the users connected to the requested user. For example, if it is determined that 50 of the 80 users connected to the requested user are located in Washington, D.C., then the requested user's location will be predicted to be in Washington, D.C. Once the demographic information has been predicted, the predicted demographic information can be provided to the requester at operation 414 of FIG. 4.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

We claim:

1. A method for predicting demographic information of a user, comprising:
identifying a first user within a social link network;
identifying one or more users connected to the first user within the social link network;
identifying demographic information of at least one of the one or more connected users; and
predicting demographic information for the first user based on the demographic information of the at least one of the one or more connected users.

2. The method according to claim 1, wherein the predicted demographic information is the age of the first user.

3. The method according to claim 1, wherein the predicted demographic information is the geographical location of the first user.

4. The method according to claim 2, wherein predicting the age of the first comprises calculating a median age of the one or more connected users.

5. The method according to claim 4, wherein the age of the first user is predicted using the age of at least three connected users.

6. The method according to claim 3, wherein predicting the geographical location of the first user comprises identifying the most common geographical location among the one or more connected users.

7. The method according to claim 1, wherein the one or more connected users are identified by using web log information from at least one of messenger activity and blog activity.

8. A method for predicting demographic information of a user, comprising:
creating a social link network;
receiving a search request for demographic information related to a first user within the social link network; and
providing the requested demographic information based on demographic information of one or more users connected to the first user within the social link network.

9. The method according to claim 8, wherein creating the social link network comprises connecting users with other users that are socially related to the users.

10. The method according to claim 9, wherein the users are socially related to the other users by using web log information from at least one of messenger activity and blog activity.

11. The method according to claim 8, wherein demographic information of the one or more users is derived from one or more registered users.

12. The method according to claim 8, wherein the requested demographic information is based on demographic information of at least three users other than the first user.

13. The method according to claim 12, wherein at least one of the at least three users are not directly connected to the first user within the social link network.

14. One or more computer-readable media having computer-usable instructions stored thereon for performing a method for predicting demographic information of a user, the method comprising:
connecting users together within social link network;
obtaining demographic information of one more users connected to a first user, the one or more connected users being registered users with known demographic information;
predicting demographic information for the first user based on the demographic information of the one or more connected users.

15. The computer-readable media according to claim 14, wherein the first user has at least one of unknown and inaccurate demographic information before predicting the first user's demographic information.

16. The computer-readable media according to claim 14, wherein the users within the social link network are connected using web log information from at least one of messenger activity and blog activity.

17. The computer-readable media according to claim 14, wherein the demographic information is obtained from at least three connected users.

18. The computer-readable media according to claim 14, wherein at least one of the at least three connected users are not directly connected to the first user within the social link network.

19. The computer-readable media according to claim 18, wherein demographic information of one or more users connected to the at least one user not directly connected to the first user is used to predict the demographic information of the first user.

20. The computer-readable media according to claim 14, wherein the predicted demographic information is the age of the first user, the age of the first being predicted by calculating a median age of the one or more connected users.
